(19) United States
(12) Patent Application Publication
(10) Pub. No.: US 2023/0222738 A1
(43) Pub. Date: Jul. 13, 2023

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Junji OTSUKA, Kanagawa (JP); Matthew LAWRENSON, Lausanne (CH); Harm CRONIE, Echallens (CH)

(73) Assignee: SONY GROUP CORPORATION, Tokyo (JP)

(21) Appl. No.: 17/922,919

(22) PCT Filed: Apr. 27, 2021
(86) PCT No.: PCT/JP2021/016720

§ 371 Date: Nov. 2, 2022

(30) Foreign Application Priority Data
May 25, 2020 (JP) 2020-090235

(51) Int. Cl. G06T 19/00; G02B 27/01

(52) U.S. Cl. CPC G06T 19/006; G02B 27/017

(57) ABSTRACT

Provided is an information processing apparatus (500) including a control section (504) that dynamically changes each parameter related to display of a virtual object, the parameter controlling display of the virtual object on each display device according to a method of expressing an image, the method being assigned for display of the image to each of a plurality of display devices that display images related to the same virtual object.

### FIELD

The present invention relates to an information processing apparatus, an information processing method, and a program.

### BACKGROUND

In recent years, technologies called augmented reality (AR) in which virtual objects are superimposed and displayed on a real space and presented to a user and mixed reality (MR) in which information of a real space is reflected in a virtual space have attracted attention as information additional to the real world. From such a background, various studies have also been made on a user interface assuming use of the AR technology and the MR technology. For example, Patent Literature 1 below discloses a technology for displaying display contents of a display unit of a mobile terminal held by a user as a virtual object on a virtual space displayed on a head mounted display (HMD) worn by the user. Then, according to the above technology, the user can use the mobile terminal as a controller by performing a touch operation on the mobile terminal while visually recognizing the virtual object.

### CITATION LIST

### Patent Literature

Patent Literature 1: JP 2018-036974A

### SUMMARY

### Technical Problem

With further use of the AR technology and the MR technology, it is assumed that a plurality of display devices are simultaneously used by a user as in Patent Literature 1. However, in the related art, in use of a plurality of display devices that simultaneously display the same virtual object, sufficient consideration has not been made on improvement of user experience and improvement of operability.

Therefore, the present disclosure proposes an information processing apparatus, an information processing method, and a program capable of further improving the user experience and the operability in use of a plurality of display devices that simultaneously display the same virtual object.

### Solution to Problem

According to the present disclosure, an information processing apparatus is provided. The information processing apparatus includes a control section configured to dynamically change each parameter related to display of a virtual object, the parameter controls display of the virtual object on each display device according to a method of expressing an image, the method is assigned for display of the image to each of a plurality of display devices that display an image related to a same virtual object.

Also, according to the present disclosure, an information processing method is provided. The information processing method includes dynamically changing, by an information processing apparatus, each parameter related to display of a virtual object, the parameter controls display of the virtual object on each display device according to a method of expressing an image, the method is assigned for display of the image to each of a plurality of display devices that display an image related to a same virtual object.

Moreover, according to the present disclosure, a program is provided. The program causes a computer to function as a control section that dynamically changes each parameter related to display of a virtual object, the parameter controls display of the virtual object on each display device according to a method of expressing an image, the method is assigned for display of the image to each of a plurality of display devices that display an image related to a same virtual object.

### BRIEF DESCRIPTION OF DRAWINGS

FIG. 1 is an explanatory diagram for describing an outline of the present disclosure.

FIG. 2 is a block diagram illustrating an example of a configuration of an information processing system 10 according to a first embodiment of the present disclosure.

FIG. 3 is a flowchart illustrating an example of an information processing method according to the embodiment.

FIG. 4 is an explanatory diagram (part 1) for describing an example of display according to the embodiment.

FIG. 5 is an explanatory diagram (part 2) for describing an example of display according to the embodiment.

FIG. 6 is an explanatory diagram (part 3) for describing an example of display according to the embodiment.

FIG. 7 is an explanatory diagram for describing an example of display control according to the embodiment.

FIG. 8 is an explanatory diagram for describing an outline of a second embodiment of the present disclosure.

FIG. 9 is a flowchart illustrating an example of an information processing method according to the embodiment.

FIG. 10 is an explanatory diagram for describing an example of display control according to the embodiment.

FIG. 11 is an explanatory diagram for describing an example of display according to the embodiment.

FIG. 12 is an explanatory diagram for describing an outline of a third embodiment of the present disclosure.

FIG. 13 is a flowchart (part 1) for describing an example of an information processing method according to the embodiment.

FIG. 14 is a flowchart (part 2) for describing an example of an information processing method according to the embodiment.

FIG. 15 is an explanatory diagram for describing an example of a method of specifying a selection device according to the embodiment.

FIG. 16 is an explanatory diagram for describing an outline of a modification example of the third embodiment of the present disclosure.

FIG. 17 is a hardware configuration diagram illustrating an example of a computer 1000 that implements functions of a control unit 500.

### DESCRIPTION OF EMBODIMENTS

Hereinafter, preferred embodiments of the present disclosure will be described in detail with reference to the accompanying drawings. Note that, in the present specification and the drawings, components having substantially the same functional configuration are denoted by the same reference numerals, and redundant description is omitted.

In addition, in the present specification and the drawings, a plurality of components having substantially the same or similar functional configuration may be distinguished by attaching different alphabets after the same reference numeral. However, in a case where it is not particularly necessary to distinguish each of a plurality of components having substantially the same or similar functional configuration, only the same reference numeral is attached.

Note that, in the following description, a virtual object means a virtual object that can be perceived by a user as a real object existing in a real space. Specifically, the virtual object can be, for example, an animation of a character, an item, or the like of a game to be displayed or projected, an icon as a user interface, a text (a button or the like), or the like.

Furthermore, in the following description, the AR display is to display the virtual object so as to be superimposed on the real space visually recognized by the user so as to expand the real world. Furthermore, a virtual object presented to the user as additional information in the real world by the AR display is also referred to as an annotation. Furthermore, in the following description, a non-AR display is a display other than displaying to expand the real world by superimposing additional information on the real space. In the present embodiment, for example, the non-AR display includes displaying the virtual object on the virtual space or simply displaying only the virtual object.

Note that the description will be given in the following order.

1. Overview

1.1 Background

1.2 Overview of Embodiment of Present Disclosure

2. First Embodiment

2.1 Schematic Configuration of Information Processing System 10

2.2 Detailed Configuration of Control Unit 500

2.3 Information Processing Method

3. Second Embodiment

3.1 Detailed Configuration of Control Unit 500

3.2 Information Processing Method

4. Third Embodiment

4.1 Detailed Configuration of Control Unit 500

4.2 Information Processing Method

4.3 Modification Example

5. Summary

6. Hardware Configuration

7. Supplement

1. Overview

<1.1 Background>

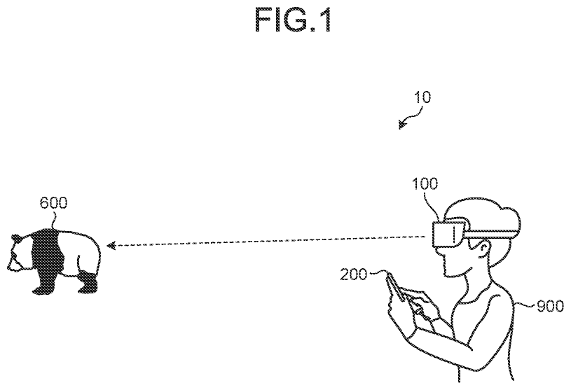

First, the background of the present disclosure will be described with reference to FIG. 1. FIG. 1 is an explanatory diagram for describing an outline of the present disclosure. In the present disclosure, as illustrated in FIG. 1, an information processing system 10 that can be used in a situation where a user 900 visually recognizes a virtual object 600 and controls the virtual object 600 using two devices will be considered.

In detail, one of the two devices is assumed to be an AR device (first display device) 100 capable of superimposing and displaying the virtual object 600 on a real space so that the user 900 can perceive the virtual object as a real object (real object) existing in the real space, for example, a head mounted display (HMD) illustrated in FIG. 1.

That is, the AR device 100 can be said to be a display device using the above-described AR display as an image expression method. Furthermore, one of the two devices is assumed to be a non-AR device (second display device) 200 that can display the virtual object 600 although not displayed to be perceived by the user 900 as the real object (real object) existing in the real space, such as a smartphone illustrated in FIG. 1, for example. That is, it can be said that the non-AR device 200 is a display device using the above-described non-AR display as the image expression method.

Then, in the present disclosure, a situation is assumed in which the user 900 can visually recognize the same virtual object 600 and performs an operation on the virtual object 600 using the AR device 100 and the non-AR device 200. More specifically, in the present disclosure, for example, a situation is assumed in which the user 900 checks the entire image and profile information of a character, a video from the viewpoint of the character, a map, and the like using the non-AR device 200 while interacting with the character, which is the virtual object 600 perceived as being present in the same space as the user himself/herself, using the AR device 100.

Then, in the situation assumed in the present disclosure, since the perception of the user 900 is different with respect to the display of the virtual object 600 by two devices using different expression methods, the present inventors considered that it is preferable to display the virtual object 600 so as to have a form corresponding to an expression method assigned to each device.

Specifically, in the AR device 100, the present inventors have selected control such that the display of the virtual object 600 changes according to a distance between the user 900 and the virtual position of the virtual object 600 in the real space and the position of the viewpoint of the user 900 so that the user 900 can perceive as the real object existing in the real space. Meanwhile, since the non-AR device 200 is not required to be able to perceive as the real object existing in the real space, the present inventors have considered that the display of the virtual object 600 may not change according to the distance or the position of the viewpoint. That is, the present inventors have selected that the display of the virtual object 600 is independently controlled without depending on the distance or the position of the viewpoint in the non-AR device 200.

That is, the present inventors have considered that in the above situation, in order to enable display of the natural virtual object 600 and to further improve user experience and operability, it is preferable that display of the virtual objects 600 on two devices using different expression methods have different forms, different changes, or different reactions to operations from the user 900. Then, the present inventors have created embodiments of the present disclosure on the basis of such an idea.

<1.2 Outline of Embodiment of Present Disclosure>In the embodiment of the present disclosure created by the present inventors, in a situation where the same virtual object 600 is displayed by a plurality of display devices including the AR device 100 and the non-AR device 200 described above, different controls are performed regarding the display of the virtual object 600 according to the expression method assigned to each display device. Specifically, in the embodiment of the present disclosure, the display of the virtual object 600 on the AR device 100 is controlled using a parameter that dynamically changes according to the distance between the user 900 and the virtual position of the virtual object 600 in the real space or the position of the viewpoint of the user 900. Meanwhile, in the embodiment of the present disclosure, the display of the virtual object 600 on the non-AR device 200 is controlled using a predefined parameter that does not dynamically change according to the distance or the position.

In the embodiment of the present disclosure, in this way, the display of the virtual object 600 on the AR device 100 and the non-AR device 200 using the expression method in which the perception of the user 900 is different will react differently to different forms, different changes, or operations from the user 900. Therefore, in the embodiment of the present disclosure, more natural display of the virtual object 600 becomes possible, and user experience and operability can be further improved. Hereinafter, details of each embodiment of the present disclosure will be sequentially described.

### 2. First Embodiment

<2.1 Schematic Configuration of Information Processing System 10>

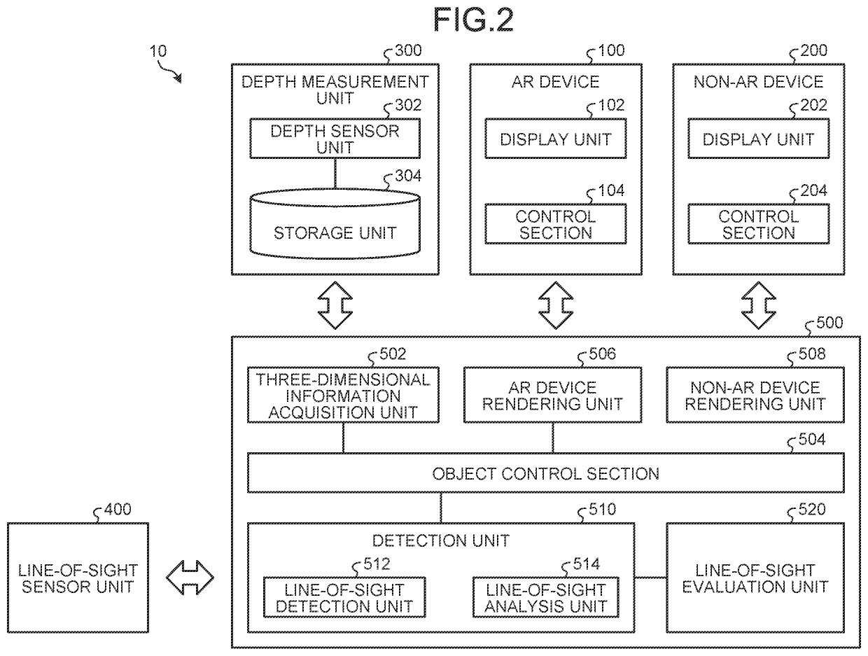

First, a schematic configuration of the information processing system 10 according to the first embodiment of the present disclosure will be described with reference to FIG. 2. FIG. 1 is a block diagram illustrating an example of a configuration of the information processing system 10 according to the present embodiment. As illustrated in FIG. 1, the information processing system 10 according to the present embodiment can include, for example, the AR device (first display device) 100, the non-AR device (second display device) 200, a depth measurement unit (real space information acquisition device) 300, a line-of-sight sensor unit (line-of-sight detection device) 400, and a control unit (information processing apparatus) 500.

Note that, in the present embodiment, the AR device 100 may be a device integrated with one, two, or all of the depth measurement unit 300, the line-of-sight sensor unit 400, and the control unit 500, that is, may not be realized by a single device. Furthermore, the number of AR devices 100, non-AR devices 200, depth measurement units 300, and line-of-sight sensor units 400 included in the information processing system 10 is not limited to the number illustrated in FIG. 2, and may be larger.

Furthermore, the AR device 100, the non-AR device 200, the depth measurement unit 300, the line-of-sight sensor unit 400, and the control unit 500 can communicate with each other via various wired or wireless communication networks. Note that the type of the communication network is not particularly limited. As a specific example, the network may include a mobile communication technology (also includes GSM, UMTS, LTE, LTE-Advanced, 5G or later technologies), a wireless local area network (LAN), a dedicated line, or the like. Further, the network may include a plurality of networks, and a part of the networks may be configured as a wireless network and the rest may be configured as a wired network. Hereinafter, an outline of each device included in the information processing system 10 according to the present embodiment will be described.

(AR Device 100)

The AR device 100 is a display device that performs AR display of the scenery in the real space in which the virtual object 600 is virtually arranged, visually recognized from a first viewpoint defined as a viewpoint of the user 900 in the real space. In detail, the AR device 100 can change and display the form and the like of the virtual object 600 according to the distance between the user 900 and the virtual position of the virtual object 600 in the real space and the position of the viewpoint of the user 900. Specifically, the AR device 100 can be an HMD, a head-up display (HUD) that is provided in front of the user 900 or the like and displays an image of the virtual object 600 superimposed on the real space, a projector that can project and display an image of the virtual object 600 in the real space, or the like. That is, the AR device 100 is a display device that displays the virtual object 600 by superimposing the virtual object 600 on the optical image of the real object located in the real space as if the virtual object existed at the virtually set position in the real space.

Furthermore, as illustrated in FIG. 2, the AR device 100 includes a display unit 102 that displays the virtual object 600, and a control section 104 that controls the display unit 102 in accordance with a control parameter from the control unit 500 to be described later.

Hereinafter, a configuration example of the display unit 102 in a case where the AR device 100 according to the present embodiment is, for example, an HMD worn on at least a part of the head of the user 900 for use will be described. In this case, examples of the display unit 102 to which the AR display can be applied include a see-through type, a video see-through type, and a retinal projection type.

The see-through type display unit 102 uses, for example, a half mirror or a transparent light guide plate to hold a virtual image optical system including a transparent light guide unit or the like in front of the eyes of the user 900 and display an image inside the virtual image optical system. Therefore, the user 900 wearing the HMD having the see-through type display unit 102 can view the scenery in the external real space even while viewing the image displayed inside the virtual image optical system. With such a configuration, the see-through type display unit 102 can superimpose the image of the virtual object 600 on the optical image of the real object located in the real space on the basis of the AR display, for example.

In a case where the video see-through type display unit 102 is worn on the head or the face of the user 900, the video see-through type display unit is worn so as to cover the eyes of the user 900 and is held in front of the eyes of the user 900. Furthermore, the HMD including the video see-through type display unit 102 includes an outward camera (not illustrated) for imaging the surrounding scenery, and causes the display unit 102 to display the image of the scenery in front of the user 900 imaged by the outward camera. With such a configuration, the user 900 wearing the HMD having the video see-through type display unit 102 can confirm the external scenery (real space) from the image displayed on the display although it is difficult to directly take the external scenery into view. Furthermore, at this time, the HMD can superimpose the image of the virtual object 600 on the image of the outside scenery on the basis of the AR display, for example.

The retinal projection type display unit 102 includes a projection unit (not illustrated) held in front of the eyes of the user 900, and the projection unit projects an image toward the eyes of the user 900 so that the image is superimposed on the outside scenery. More specifically, in the HMD including the retinal projection type display unit 102, an image is directly projected from the projection unit onto the retina of the eye of the user 900, and the image is formed on the retina. With such a configuration, even in the case of the user 900 who is near-sighted or far-sighted, it is possible to view a clearer video. Furthermore, the user 900 wearing the HMD having the retinal projection type display unit 102 can view the external scenery (real space) even while viewing the image projected from the projection unit. With such a configuration, the HMD including the retinal projection type display unit 102 can superimpose the image of the virtual object 600 on the optical image of the real object located in the real space on the basis of the AR display, for example.

Furthermore, in the present embodiment, the AR device 100 can also be a smartphone, a tablet, or the like that can display the virtual object 600 superimposed on an image of the real space viewed from the position of a mounted camera (not illustrated) held by the user 900. In such a case, the above-described first viewpoint is not limited to the viewpoint of the user 900 in the real space, but is the position of the camera of the smartphone held by the user 900.

Furthermore, the control section 104 included in the AR device 100 controls the overall operation of the display unit 102 in accordance with parameters and the like from the control unit 500 to be described later. The control section 104 can be realized by, for example, an electronic circuit of a microprocessor such as a central processing unit (CPU) or a graphics processing unit (GPU). Furthermore, the control section 104 may include a read only memory (ROM) that stores programs, operation parameters, and the like to be used, a random access memory (RAM) that temporarily stores parameters and the like that change appropriately, and the like. For example, the control section 104 performs control to dynamically change the display of the virtual object 600 on the display unit 102 according to the parameter from the control unit 500 according to the distance between the user 900 and the virtual position of the virtual object 600 in the real space.

Furthermore, the AR device 100 may include a communication unit (not illustrated) which is a communication interface that can be connected to an external device by wireless communication or the like. The communication unit is realized by, for example, a communication device such as a communication antenna, a transmission/reception circuit, or a port.

Furthermore, in the present embodiment, the AR device 100 may be provided with a button (not illustrated), a switch (not illustrated), and the like (an example of an operation input unit) for performing an input operation by the user 900. Furthermore, as the input operation of the user 900 with respect to the AR device 100, various input methods such as an input by voice, a gesture input by a hand or a head, and an input by a line-of-sight can be selected in addition to the operation with respect to the buttons and the like as described above. Note that input operations by these various input methods can be acquired by various sensors (sound sensor (not illustrated), camera (not illustrated), and motion sensor (not illustrated)) or the like provided in the AR device 100. In addition, the AR device 100 may be provided with a speaker (not illustrated) that outputs a voice to the user 900.

Furthermore, in the present embodiment, the AR device 100 may be provided with the depth measurement unit 300, the line-of-sight sensor unit 400, and the control unit 500 as described later.

In addition, in the present embodiment, the AR device 100 may be provided with a positioning sensor (not illustrated). The positioning sensor is a sensor that detects the position of the user 900 wearing the AR device 100, and specifically, can be a global navigation satellite system (GNSS) receiver or the like. In this case, the positioning sensor can generate sensing data indicating the latitude and longitude of a current location of the user 900 on the basis of a signal from a GNSS satellite. Furthermore, in the present embodiment, since it is possible to detect the relative positional relationship of the user 900 from, for example, radio frequency identification (RFID), information on an access point of Wi-Fi, information on a radio base station, and the like, a communication device for such communication can also be used as the positioning sensor. Furthermore, in the present embodiment, the position and posture of the user 900 wearing the AR device 100 may be detected by processing (cumulative calculation or the like) sensing data of an acceleration sensor, a gyro sensor, a geomagnetic sensor, or the like included in the motion sensor (not illustrated) described above.

(Non-AR Device 200)

The non-AR device 200 is a display device that can non-AR display the image of the virtual object 600 toward the user 900. In detail, it is possible to display the virtual object 600 visually recognized from a second viewpoint at a position different from the first viewpoint defined as the viewpoint of the user 900 in the real space. In the present embodiment, the second viewpoint may be a position virtually set in the real space, may be a position separated by a predetermined distance from the position of the virtual object 600 or the user 900 in the real space, or may be a position set on the virtual object 600. The non-AR device 200 can be, for example, a smartphone or a tablet personal computer (PC) carried by the user 900, a smart watch worn on an arm of the user 900, or the like. Furthermore, as illustrated in FIG. 2, the non-AR device 200 includes a display unit 202 that displays the virtual object 600, and a control section 204 that controls the display unit 202 in accordance with a control parameter or the like from the control unit 500 described later.

The display unit 202 is provided on the surface of the non-AR device 200, and can perform non-AR display of the virtual object 600 to the user 900 by being controlled by the control section 204. For example, the display unit 202 can be realized from a display device such as a liquid crystal display (LCD) device and organic light emitting diode (OLED) device.

Furthermore, the control section 204 controls the overall operation of the display unit 202 in accordance with control parameters and the like from the control unit 500 described later. The control section 204 is realized by, for example, an electronic circuit of a microprocessor such as a CPU or a GPU. Furthermore, the control section 204 may include a ROM that stores programs to be used, operation parameters, and the like, a RAM that temporarily stores parameters and the like that change as appropriate, and the like.

Furthermore, the non-AR device 200 may include a communication unit (not illustrated) which is a communication interface that can be connected to an external device by wireless communication or the like. The communication unit is realized by, for example, a communication device such as a communication antenna, a transmission/reception circuit, or a port.

Furthermore, in the present embodiment, the non-AR device 200 may be provided with an input unit (not illustrated) for the user 900 to perform an input operation. The input unit includes, for example, an input device such as a touch panel or a button. In the present embodiment, the non-AR device 200 can function as a controller that can change the operation, position, and the like of the virtual object 600. In addition, the non-AR device 200 may be provided with a speaker (not illustrated) that outputs a voice to the user 900, a camera (not illustrated) that can image a real object in the real space or a figure of the user 900, and the like.

Furthermore, in the present embodiment, the non-AR device 200 may be provided with the depth measurement unit 300, the line-of-sight sensor unit 400, and the control unit 500 as described later. In addition, in the present embodiment, the non-AR device 200 may be provided with a positioning sensor (not illustrated). Furthermore, in the present embodiment, the non-AR device 200 may be provided with a motion sensor (not illustrated) including an acceleration sensor, a gyro sensor, a geomagnetic sensor, and the like.

(Depth Measurement Unit 300)

The depth measurement unit 300 may obtain three-dimensional information of the real space around the user 900. Specifically, as illustrated in FIG. 2, the depth measurement unit 300 includes a depth sensor unit 302 capable of acquiring the three-dimensional information, and a storage unit 304 that stores the acquired three-dimensional information. For example, the depth sensor unit 302 may be a time-of-flight (TOF) sensor (distance measuring device) that acquires depth information of a real space around the user 900, and an imaging device such as a stereo camera or a structured light sensor. In the present embodiment, the three-dimensional information of the real space around the user 900 obtained by the depth sensor unit 302 can be used not only as the environmental information around the user 900 but also for obtaining position information including distance information and positional relationship information between the virtual object 600 and the user 900 in the real space.

Specifically, the TOF sensor irradiates the real space around the user 900 with irradiation light such as infrared light, and detects reflected light reflected by the surface of the real object (wall or the like) in the real space. Then, the TOF sensor can acquire the distance (depth information) from the TOF sensor to the real object by calculating a phase difference between the irradiation light and the reflected light, and thus, can obtain a distance image including the distance information (depth information) to the real object as the three-dimensional shape data of the real space. Note that the method of obtaining the distance information by the phase difference as described above is referred to as an indirect TOF method. Furthermore, in the present embodiment, it is also possible to use the direct TOF method capable of acquiring the distance (depth information) from the TOF sensor to the real object by detecting a round-trip time of light from a time point when irradiation light is emitted until the irradiation light is reflected by the real object and received as reflected light.

Here, the distance image is, for example, information generated by associating distance information (depth information) acquired for each pixel of the TOF sensor with position information of the corresponding pixel. Furthermore, here, the three-dimensional information is three-dimensional coordinate information (specifically, an aggregate of a plurality of pieces of three-dimensional coordinate information) in the real space generated by converting the position information of the pixel in the distance image into coordinates in the real space on the basis of the position in the real space of the TOF sensor and associating the distance information corresponding to the coordinates obtained by the conversion. In the present embodiment, the position and shape of a shielding object (wall or the like) in the real space can be grasped by using such a distance image and three-dimensional information.

Furthermore, in the present embodiment, in a case where the TOF sensor is provided in the AR device 100, the position and posture of the user 900 in the real space may be detected by comparing the three-dimensional information obtained by the TOF sensor with a three-dimensional information model (a position, a shape, or the like of a wall) of the same real space (indoor space or the like) acquired in advance. Furthermore, in the present embodiment, in a case where the TOF sensor is installed in the real space (indoor space or the like), the position and posture of the user 900 in the real space may be detected by extracting a shape of a person from the three-dimensional information obtained by the TOF sensor. In the present embodiment, the position information of the user 900 detected in this manner can be used to obtain position information including distance information and positional relationship information between the virtual object 600 and the user 900 in the real space. Furthermore, in the present embodiment, a virtual landscape of the real space (illustration imitating the real space) based on the three-dimensional information may be generated and displayed on the above-described non-AR device 200 or the like.

Furthermore, the structured light sensor irradiates a predetermined pattern with light such as infrared rays to the real space around the user 900 and captures the image, whereby a distance image including the distance (depth information) from the structured light sensor to the real object can be obtained on the basis of the deformation of the predetermined pattern obtained from the imaging result. Further, the stereo camera can simultaneously capture the real space around the user 900 with the two cameras from two different directions, and use the parallax of these cameras to acquire the distance (depth information) from the stereo camera to the real object.

Furthermore, the storage unit 304 can store a program or the like for the depth sensor unit 302 to execute sensing, and three-dimensional information obtained by sensing. The storage unit 304 is realized by, for example, a magnetic recording medium such as a hard disk (HD), a nonvolatile memory such as a flash memory, or the like.

Furthermore, the depth measurement unit 300 may include a communication unit (not illustrated) which is a communication interface that can be connected to an external device by wireless communication or the like. The communication unit is realized by, for example, a communication device such as a communication antenna, a transmission/reception circuit, or a port.

Furthermore, in the present embodiment, as described above, the depth measurement unit 300 may be provided in the AR device 100 or the non-AR device 200 described above. Alternatively, in the present embodiment, the depth measurement unit 300 may be installed in the real space (for example, in indoor space or the like) around the user 900, and in this case, position information of the depth measurement unit 300 in the real space is known.

(Line-of-Sight Sensor Unit 400)

The line-of-sight sensor unit 400 can image the eyeball of the user 900 and detect the line-of-sight of the user 900. Note that the line-of-sight sensor unit 400 is mainly used in an embodiment to be described later. The line-of-sight sensor unit 400 can be configured, for example, as an inward camera (not illustrated) in the HMD that is the AR device 100. Then, the captured video of the eye of the user 900 acquired by the inward camera is analyzed to detect the line-of-sight direction of the user 900. Note that, in the present embodiment, an algorithm of line-of-sight detection is not particularly limited, but for example, the line-of-sight detection can be realized on the basis of a positional relationship between the inner corner of the eye and the iris, or a positional relationship between the corneal reflection (Purkinje image or the like) and the pupil. Furthermore, in the present embodiment, the line-of-sight sensor unit 400 is not limited to the inward camera as described above, and may be a camera that can image the eyeball of the user 900 or an electro-oculography sensor that measures the electro-oculography by attaching an electrode around the eye of the user 900. Furthermore, in the present embodiment, the line-of-sight direction of the user 900 may be recognized using a model obtained by machine learning. Note that details of recognition of the line-of-sight direction will be described in an embodiment to be described later.

Furthermore, the line-of-sight sensor unit 400 may include a communication unit (not illustrated) that is a communication interface that can be connected to an external device by wireless communication or the like. The communication unit is realized by, for example, a communication device such as a communication antenna, a transmission/reception circuit, or a port.

Furthermore, in the present embodiment, as described above, the line-of-sight sensor unit 400 may be provided in the AR device 100 or the non-AR device 200 described above. Alternatively, in the present embodiment, the line-of-sight sensor unit 400 may be installed in the real space (for example, in indoor space or the like) around the user 900, and in this case, position information of the line-of-sight sensor unit 400 in the real space is known.

(Control Unit 500)

The control unit 500 is a device for controlling display on the AR device 100 and the non-AR device 200 described above. Specifically, in the present embodiment, the AR display of the virtual object 600 by the AR device 100 is controlled by the control unit 500 using a parameter that dynamically changes according to the distance between the user 900 and the virtual position of the virtual object 600 in the real space and the position of the viewpoint of the user 900. Furthermore, in the present embodiment, the display of the virtual object 600 by the non-AR device 200 is also controlled by the control unit 500 using a predefined parameter. Furthermore, the control unit 500 can mainly include a CPU, a RAM, a ROM, and the like. Furthermore, the control unit 500 may include a communication unit (not illustrated) which is a communication interface that can be connected to an external device by wireless communication or the like. The communication unit is realized by, for example, a communication device such as a communication antenna, a transmission/reception circuit, or a port.

Furthermore, in the present embodiment, as described above, the control unit 500 may be provided in the AR device 100 or the non-AR device 200 described above (provided as an integrated device), and by doing so, it is possible to suppress a delay at the time of display control. Alternatively, in the present embodiment, the control unit 500 may be provided as a device separate from the AR device 100 and the non-AR device 200 (for example, it may be a server or the like existing on a network.). A detailed configuration of the control unit 500 will be described later.

<2.2 Detailed Configuration of Control Unit 500>

Next, a detailed configuration of the control unit 500 according to the present embodiment will be described with reference to FIG. 2. As described above, the control unit 500 can control the display of the virtual objects 600 displayed at the AR device 100 and the non-AR device 20. Specifically, as illustrated in FIG. 2, the control unit 500 mainly includes a three-dimensional information acquisition unit (position information acquisition unit) 502, an object control section (control section) 504, an AR device rendering unit 506, a non-AR device rendering unit 508, a detection unit (selection result acquisition unit) 510, and a line-of-sight evaluation unit 520. Hereinafter, details of each functional unit of the control unit 500 will be sequentially described.

(Three-Dimensional Information Acquisition Unit 502)

The three-dimensional information acquisition unit 502 acquires three-dimensional information of the real space around the user 900 from the depth measurement unit 300 described above, and outputs the three-dimensional information to the object control section 504 described later. The three-dimensional information acquisition unit 502 may extract information such as the position, posture, and shape of the real object in the real space from the three-dimensional information and output the information to the object control section 504. Furthermore, the three-dimensional information acquisition unit 502 may refer to the position information in the real space virtually allocated for displaying the virtual object 600, generate position information including distance information and positional relationship information between the virtual object 600 and the user 900 in the real space on the basis of the three-dimensional information, and output the position information to the object control section 504. Further, the three-dimensional information acquisition unit 502 may acquire the position information of the user 900 in the real space from not only the depth measurement unit 300 but also the above-described positioning sensor (not illustrated).

(Object Control Section 504)

The object control section 504 controls the display of the virtual object 600 in the AR device 100 and the non-AR device 200 according to the expression method assigned to each of the AR device 100 and the non-AR device 200 for the display of the virtual object 600. Specifically, the object control section 504 dynamically changes each parameter (for example, the display change amount of the virtual object 600 in the moving image display, the display change amount changed by the input operation of the user 900, and the like) related to the display of the virtual object 600 according to the expression method assigned to each of the AR device 100 and the non-AR device 200 for the display of the virtual object 600. Then, the object control section 504 outputs the parameters changed in this way to the AR device rendering unit 506 and the non-AR device rendering unit 508 to be described later. The output parameters are used to control the display of the virtual object 600 in the AR device 100 and the non-AR device 200.

More specifically, for example, the object control section 504 dynamically changes the parameter related to the display of the virtual object 600 on the AR device 100 according to the position information including the distance between the virtual object 600 and the user 900 in the real space based on the three-dimensional information acquired from the depth measurement unit 300.

More specifically, as the distance between the virtual object 600 and the user 900 becomes longer (farther), the size of the virtual object 600 displayed on the AR device 100 becomes smaller so that the user 900 perceives it as a real object existing in the real space. Therefore, the visibility of the virtual object 600 of the user 900 decreases, and for example, in a case where the virtual object 600 is a character of a game or the like, fine movement of the character becomes difficult to be visually recognized. Therefore, in the present embodiment, the object control section 504 changes the parameter so that the display change amount (the degree of quantization of the movement (jump or the like) of the virtual object 600) in the moving image display of the virtual object 600 to be displayed on the AR device 100 increases as the distance increases. Furthermore, the object control section 504 changes the parameter so as to smooth a trajectory in the moving image display of the virtual object 600 to be displayed on the AR device 100 as the distance increases. By doing so, in the present embodiment, even when the size of the virtual object 600 displayed on the AR device 100 decreases so as to be perceived by the user 900 as the real object existing in the real space, it is possible to suppress a decrease in the visibility of the movement of the virtual object 600.

Furthermore, in the present embodiment, although it becomes difficult for the user 900 to perceive the virtual object as a real object existing in the real space, the object control section 504 may change the parameter so that the display area of the virtual object 600 to be displayed on the AR device 100 increases as the distance between the virtual object 600 and the user 900 increases. Furthermore, in the present embodiment, the object control section 504 may change the parameter so that the virtual object 600 is more likely to approach, move away, or take an action such as an attack with respect to another virtual object displayed on the AR device 100.

Meanwhile, in the present embodiment, the object control section 504 uses a predefined parameter (for example, a fixed value) as the parameter related to the display of the virtual object 600 in the non-AR device 200. Note that, in the present embodiment, the predefined parameter may be used for display of the virtual object 600 on the non-AR device 200 after being processed by a predetermined rule.

(AR Device Rendering Unit 506)

The AR device rendering unit 506 performs rendering processing of an image to be displayed on the AR device 100 using the parameters and the like output from the object control section 504 described above, and outputs the image data after rendering to the AR device 100.

(Non-AR Device Rendering Unit 508)

The non-AR device rendering unit 508 performs rendering processing of an image to be displayed on the non-AR device 200 using the parameters and the like output from the object control section 504 described above, and outputs the image data after rendering to the non-AR device 200.

(Detection Unit 510)

As illustrated in FIG. 2, the detection unit 510 mainly includes a line-of-sight detection unit 512 and a line-of-sight analysis unit 514. The line-of-sight detection unit 512 detects a line-of-sight of the user 900 and acquires a line-of-sight direction of the user 900, and the line-of-sight analysis unit 514 specifies a device that the user 900 would have selected as a controller (input device) on the basis of the line-of-sight direction of the user 900. Then, the specified specification result (selection result) is output to the object control section 504 after being subjected to the evaluation processing in the line-of-sight evaluation unit 520 to be described later, and is used when the parameter related to the display of the virtual object 600 is changed. Note that details of processing by the detection unit 510 will be described in a third embodiment of the present disclosure described later.

(Line-Of-Sight Evaluation Unit 520)

The line-of-sight evaluation unit 520 can evaluate the specified result by calculating a probability that the user 900 selects each device as a controller using a model or the like obtained by machine learning for the device that the user 900 specified by the detection unit 510 described above would have selected as a controller. In the present embodiment, the line-of-sight evaluation unit 520 calculates the probability that the user 900 selects each device as the controller, and finally specifies the device selected as the controller by the user 900 on the basis of the probability, whereby the device selected as the controller can be accurately specified on the basis of the line-of-sight direction of the user 900 even in a case where the direction of the line-of-sight of the user 900 is not constantly fixed. Note that details of processing by the line-of-sight evaluation unit 520 will be described in the third embodiment of the present disclosure described later.

<2.3 Information Processing Method>

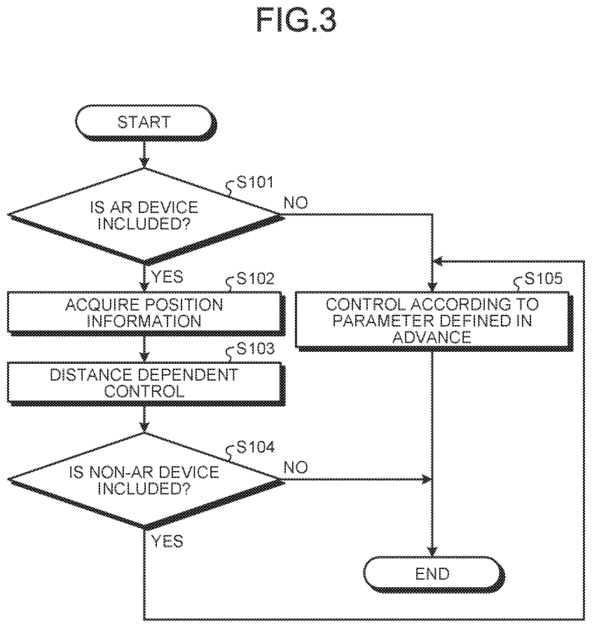

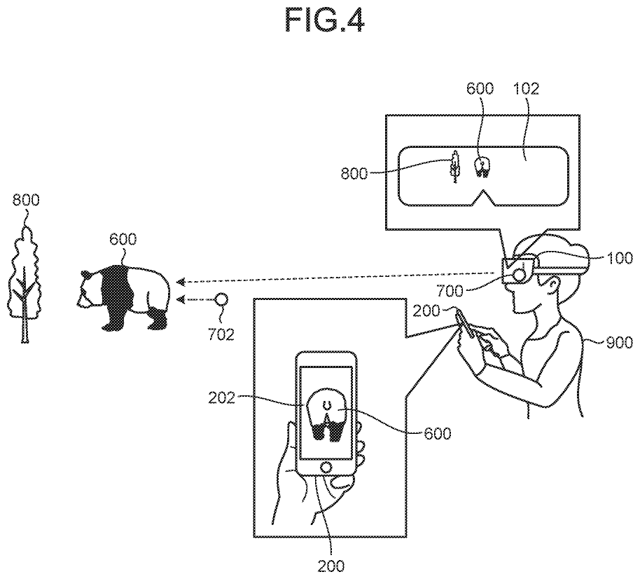

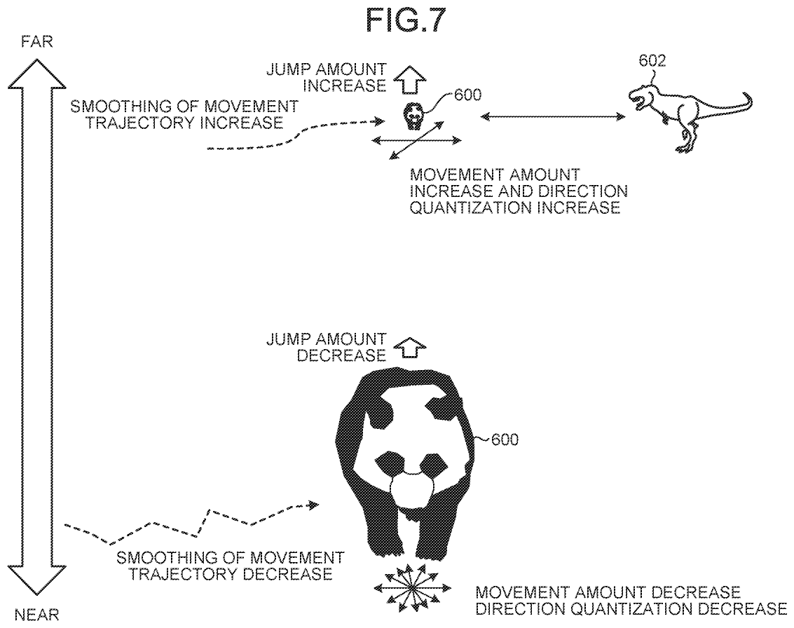

Next, an information processing method according to the first embodiment of the present disclosure will be described with reference to FIGS. 3 to 7. FIG. 3 is a flowchart for describing an example of the information processing method according to the present embodiment, FIGS. 4 to 6 are explanatory diagrams for describing an example of display according to the present embodiment, and FIG. 7 is an explanatory diagram for describing an example of display control according to the present embodiment.

Specifically, as illustrated in FIG. 3, the information processing method according to the present embodiment can include Steps from Step S101 to Step S105. Details of these Steps according to the present embodiment will be described below.

First, the control unit 500 determines whether the AR device 100 that performs the AR display is included in the display device to be controlled (Step S101). The control unit 500 proceeds to the processing of Step S102 in a case where the AR device 100 is included (Step S101: Yes), and proceeds to the processing of Step S105 in a case where the AR device 100 is not included (Step S101: No).

Next, the control unit 500 acquires position information including information on the position and posture of the user 900 in the real space (Step S102). Furthermore, the control unit 500 calculates the distance between the virtual object 600 and the user 900 in the real space on the basis of the acquired position information.

Then, the control unit 500 controls the display of the virtual object 600 displayed on the AR device 100 according to the distance calculated in Step S102 described above (distance dependent control) (Step S103). Specifically, the control unit 500 dynamically changes the parameter related to the display of the virtual object 600 on the AR device 100 according to the distance and the positional relationship between the virtual object 600 and the user 900 in the real space.

More specifically, as illustrated in FIG. 4, the display unit 102 of the AR device 100 displays the virtual object 600 to be superimposed on the image of the real space (for example, an image of the real object 800) viewed from a viewpoint (first viewpoint) 700 of the user 900 wearing the AR device 100. At this time, the control unit 500 dynamically changes the parameter so that the virtual object 600 is displayed in a form viewed from the viewpoint (first viewpoint) 700 of the user 900 so that the user 900 can perceive the virtual object as a real object existing in the real space. Furthermore, the control unit 500 dynamically changes the parameter so that the virtual object 600 is displayed to have a size corresponding to the distance calculated in Step S102 described above. Then, the control unit 500 performs rendering processing of the image to be displayed on the AR device 100 using the parameters obtained in this manner, and outputs the image data after rendering to the AR device 100, whereby the AR display of the virtual object 600 in the AR device 100 can be controlled in a distance dependent manner. Note that, in the present embodiment, in a case where the virtual object 600 moves or the user 900 moves or changes the posture, the distance dependent control is performed on the virtual object 600 to be displayed accordingly. In this way, the virtual object 600 displayed in the AR can be perceived by the user 900 as a real object existing in the real space.

Next, the control unit 500 determines whether the non-AR device 200 that performs the non-AR display is included in the display device to be controlled (Step S104). The control unit 500 proceeds to the processing of Step S105 in a case where the non-AR device 200 is included (Step S104: Yes), and ends the processing in a case where the non-AR device 200 is not included (Step S104: No).

Then, the control unit 500 controls the display of the virtual object 600 displayed on the non-AR device 200 according to the parameter defined (set) in advance (Step S105). Then, the control unit 500 ends the processing in the information processing method.

More specifically, as illustrated in FIG. 4, the display unit 202 of the non-AR device 200 displays the virtual object 600 (specifically, an image of a back surface of the virtual object 600) viewed from the viewpoint (second viewpoint) 702 virtually fixed in the real space. At this time, the control unit 500 selects a parameter defined (set) in advance, and changes the selected parameter according to the situation. Furthermore, the control unit 500 can control the non-AR display of the virtual object 600 on the non-AR device 200 by performing rendering processing of the image to be displayed on the non-AR device 200 using the parameter and outputting the rendered image data to the non-AR device 200.

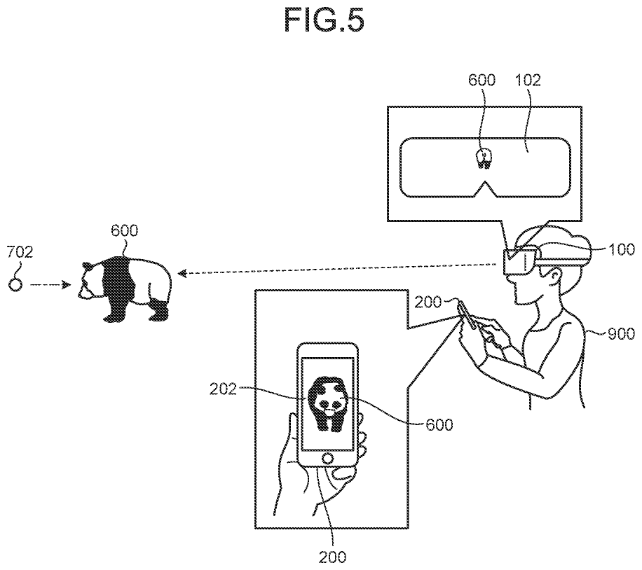

Furthermore, in the present embodiment, as illustrated in FIG. 5, in a case where the viewpoint 702 is located on the opposite side of the user 900 side with respect to the virtual position of the virtual object 600 in the real space, the display unit 202 of the non-AR device 200 may display the virtual object 600 (specifically, a front surface of the virtual object 600) in a form different from FIG. 4.

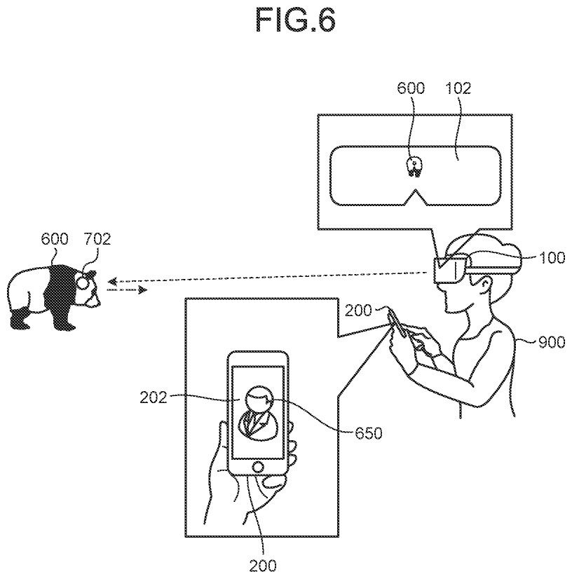

Furthermore, in the present embodiment, as illustrated in FIG. 6, in a case where the viewpoint 702 is virtually arranged in the virtual object 600, the display unit 202 of the non-AR device 200 may display an avatar 650 that causes the user 900 viewed from the viewpoint 702 to be imaged. In such a case, in a case where the virtual object 600 moves or the user 900 moves or changes the posture, the form of the avatar 650 to be displayed may be changed accordingly.

In the present embodiment, the information processing method illustrated in FIG. 3 may be repeatedly executed using a change in the virtual position of the virtual object 600 in the real space or a change in the position or posture of the user 900 as a trigger. In this way, the virtual object 600 displayed in the AR by the AR device 100 can be perceived by the user 900 as the real object existing in the real space.

In the present embodiment, as described above, the parameters related to the display of the virtual object 600 on the AR device 100 are dynamically changed according to the distance between the virtual object 600 and the user 900 in the real space (distance dependent control). Therefore, a specific example of control of the virtual object 600 displayed in the AR by the AR device 100 in the present embodiment will be described with reference to FIG. 7.

More specifically, as illustrated in FIG. 7, as the distance between the virtual object 600 and the user 900 increases, the size of the virtual object 600 displayed on the AR device 100 decreases so that the user 900 perceives it as a real object existing in the real space. Therefore, the visibility of the virtual object 600 of the user 900 decreases, and for example, in a case where the virtual object 600 is a character of a game or the like, fine movement of the character becomes difficult to be visually recognized. Therefore, in the present embodiment, the control unit 500 changes the parameter so that the display change amount (jump amount, movement amount, and direction quantization amount) in the moving image display of the virtual object 600 to be displayed on the AR device 100 increases as the distance increases. Furthermore, the control unit 500 changes the parameter so as to increase the smoothing of the trajectory in the moving image display of the virtual object 600 to be displayed on the AR device 100 as the distance increases. By doing so, in the present embodiment, even when the size of the virtual object 600 displayed on the AR device 100 decreases so as to be perceived by the user 900 as the real object existing in the real space, it is possible to suppress a decrease in the visibility of the movement of the virtual object 600.

Furthermore, in the present embodiment, as illustrated in FIG. 7, the control unit 500 may change the parameter according to the distance between the virtual object 600 and the user 900 in the real space such that the virtual object 600 moves greatly to approach or moves greatly to be far away from another virtual object 602 displayed on the AR device 100, for example, using an operation from the user 900 as a trigger. Furthermore, in the present embodiment, the control unit 500 may change the parameter according to the distance so that the virtual object 600 can easily perform an action such as attack with respect to another virtual object 602, for example, using an operation from the user 900 as a trigger. By doing so, in the present embodiment, even when the size of the virtual object 600 displayed on the AR device 100 decreases so as to be perceived by the user 900 as a real object existing in the real space, it is possible to suppress a decrease in operability of the virtual object 600.

Furthermore, in the present embodiment, although it becomes difficult for the user 900 to perceive the virtual object as the real object existing in the real space, the control unit 500 may change the parameter so that the display area of the virtual object 600 displayed on the AR device 100 increases as the distance between the virtual object 600 and the user 900 increases.

As described above, according to the present embodiment, in the AR device 100 and the non-AR device in which the way of perception by the user is different, the display of the virtual object 600 reacts differently to different forms, different changes, or operations from the user 900, and thus, it is possible to further improve the user experience and operability.

### 3. Second Embodiment

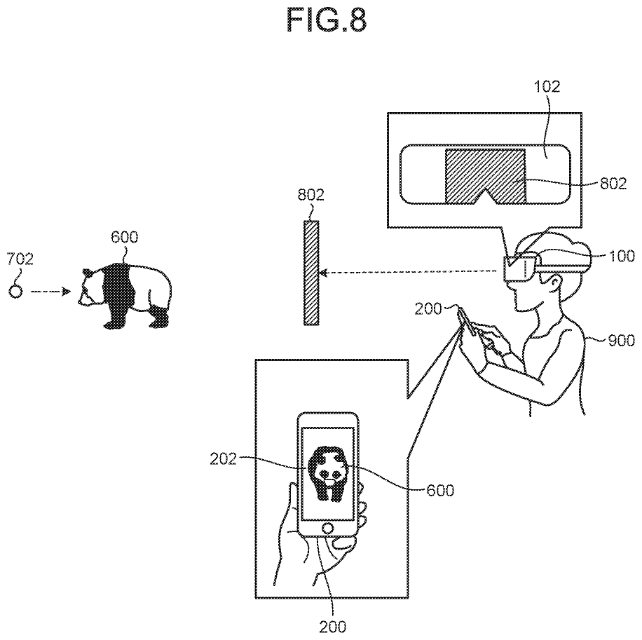

First, a situation assumed in a second embodiment of the present disclosure will be described with reference to FIG. 8. FIG. 8 is an explanatory diagram for describing an outline of the present embodiment. For example, when a user 900 plays a game using an information processing system 10 according to the present embodiment, as illustrated in FIG. 8, there is a case where a shielding object 802 such as a wall exists between the user 900 and a virtual object 600 in a real space so as to block the view of the user 900. In such a situation, the user 900 is shielded by the shielding object 802 and cannot visually recognize the virtual object 600 using the display unit 102 of the AR device 100, and thus, it becomes difficult to operate the virtual object 600.

Therefore, in the present embodiment, the display of the virtual object 600 is dynamically changed according to whether or not the display of the whole or a part of the virtual object 600 on the AR device 100 is in a situation (occurrence of occlusion) in which the display is hindered by the shielding object 802. Specifically, for example, in a situation where the virtual object 600 cannot be visually recognized due to the presence of the shielding object 802, the display unit 102 of the AR device 100 is used to change the display position of the virtual object 600 to a position where the visual recognition is not hindered by the shielding object 802. With this configuration, in the present embodiment, even in a case where the shielding object 802 that blocks the view of the user 900 exists between the user 900 and the virtual object 600 in the real space, the user 900 can easily view the virtual object 600 using the display unit 102 of the AR device 100. As a result, according to the present embodiment, it is easy for the user 900 to operate the virtual object 600.

Note that, in the present embodiment, not only in a case where the virtual object 600 cannot be visually recognized due to the presence of the shielding object 802, but also in a case where the depth information around the virtual object 600 in the real space cannot be acquired by the depth measurement unit 300 (for example, a case where a transparent real object or a black real object exists in the real space, a case where noise or the like of the depth sensor unit 302 occurs, or the like.), the display of the virtual object 600 on the AR device 100 may be dynamically changed. Alternatively, in the present embodiment, the AR device 100 may superimpose and display (AR display) another virtual object 610 (see FIG. 11) in the real space in a region where the depth information cannot be acquired. Hereinafter, details of the present embodiment will be described.

<3.1 Detailed Configuration of Control Unit 500>

Configuration examples of the information processing system 10 and the control unit 500 according to the present embodiment are similar to those of the first embodiment described above, and thus, description thereof is omitted here. However, in the present embodiment, the object control section 504 of the control unit 500 also has the following functions.

Specifically, in the present embodiment, in a case where a shielding object (shielding object) 802 that is the real object and is located between a virtual object 600 and a user 900 in the real space exists on the basis of the three-dimensional information, the object control section 504 sets a region where the shielding object 802 exists as an occlusion region. Furthermore, the object control section 504 changes the parameter in order to change the display position or the display form of the virtual object 600 or the movement amount of the virtual object 600 in the moving image display in the AR device 100 so as to reduce the region in which the virtual object 600 and the occlusion region are superimposed.

Furthermore, in the present embodiment, in a case where a region in which three-dimensional information cannot be acquired is detected (for example, a case where a transparent real object or a black real object exists in the real space, a case where noise or the like of the depth sensor unit 302 occurs, or the like.), the object control section 504 sets the region as an indefinite region. Furthermore, the object control section 504 changes the parameter in order to change the display position or the display form of the virtual object 600 or the movement amount of the virtual object 600 in the moving image display in the AR device 100 so as to reduce the region where the virtual object 600 and the indefinite region are superimposed. Furthermore, in the present embodiment, the object control section 504 may generate a parameter for displaying another virtual object (another virtual object) 610 (see FIG. 11) in the indefinite region.

<3.2 Information Processing Method>

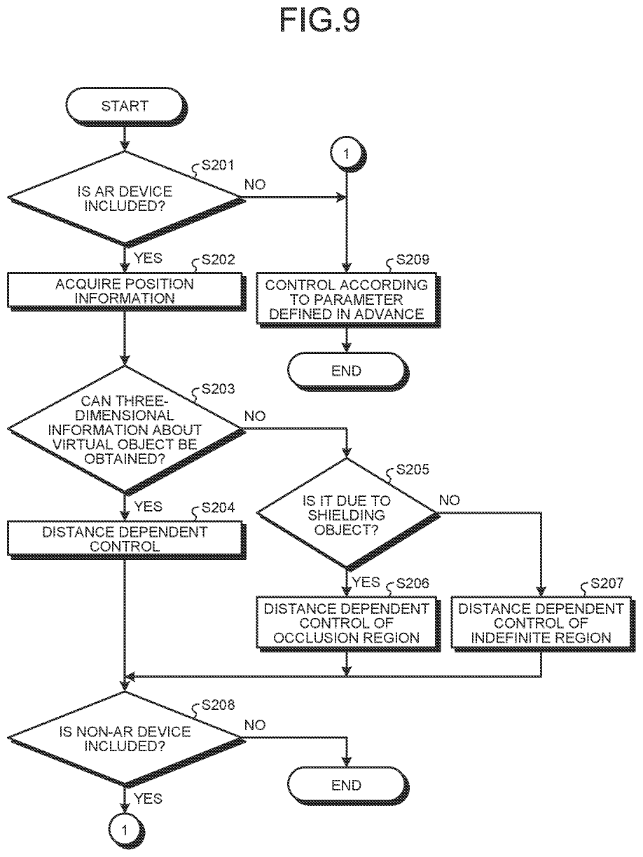

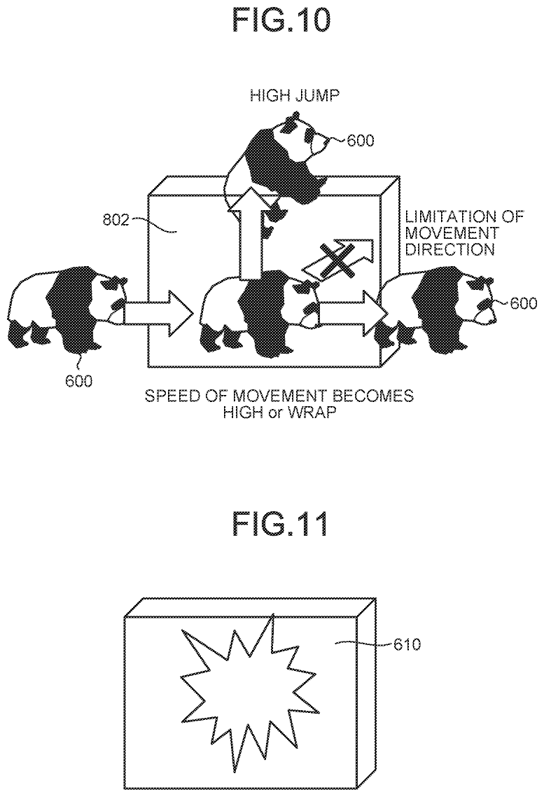

Next, an information processing method according to the second embodiment of the present disclosure will be described with reference to FIGS. 9 to 11. FIG. 9 is a flowchart for describing an example of the information processing method according to the present embodiment, FIG. 10 is an explanatory diagram for describing an example of display control according to the present embodiment, and FIG. 11 is an explanatory diagram for describing an example of display according to the present embodiment.

Specifically, as illustrated in FIG. 9, the information processing method according to the present embodiment can include Steps from Step S201 to Step S209. Details of these Steps according to the present embodiment will be described below. Note that, in the following description, only points different from the above-described first embodiment will be described, and description of points common to the first embodiment will be omitted.

Since Steps S201 and S202 are similar to Steps S101 and S102 of the first embodiment illustrated in FIG. 3, the description thereof is omitted here.

First, the control unit 500 determines whether three-dimensional information around the setting position of the virtual object 600 in the real space can be acquired (Step S203). The control unit 500 proceeds to the processing of Step S204 in a case where the three-dimensional information around the virtual object 600 in the real space can be acquired (Step S203: Yes), and proceeds to the processing of Step S205 in a case where the three-dimensional information around the virtual object 600 in the real space cannot be acquired (Step S203: No).

Since Step S204 is similar to Step S103 of the first embodiment illustrated in FIG. 3, the description thereof is omitted here.

Next, the control unit 500 determines whether three-dimensional information around the virtual object 600 cannot be acquired by the shielding object 802 (Step S205). That is, in a case where the three-dimensional information (position, posture, and shape) about the shielding object 802 can be acquired but the three-dimensional information around the setting position of the virtual object 600 in the real space cannot be acquired (Step S205: Yes), the processing proceeds to Step S206, and in a case where the three-dimensional information around the virtual object 600 cannot be acquired due to, for example, noise of the depth sensor unit 302 instead of the presence of the shielding object 802 (Step S205: No), the processing proceeds to Step S207.

Next, the control unit 500 sets the region where the shielding object 802 exists as the occlusion region. Then, the control unit 500 changes the display position or the display form of the virtual object 600 or the movement amount of the virtual object 600 in the moving image display in the AR device 100 so as to reduce the region where the virtual object 600 and the occlusion region are superimposed (distance dependent control of the occlusion region) (Step S206).

More specifically, in the present embodiment, as illustrated in FIG. 10, in a case where the whole or a part of the virtual object 600 is at a position hidden by the shielding object 802, control is performed such that the virtual object can be visually recognized or a situation in which the virtual object 600 can be visually recognized immediately comes by increasing the movement amount in the parallel direction (increasing the movement speed or warping). Furthermore, in a similar case, in the present embodiment, as illustrated in FIG. 10, the virtual object 600 may be controlled to jump high so that the virtual object 600 can be visually recognized. Furthermore, in the present embodiment, the movable direction of the virtual object 600 may be limited so that the virtual object 600 can be visually recognized (for example, the movement in the depth direction in FIG. 10 is limited).

Next, the control unit 500 sets the region where three-dimensional information around the virtual object 600 cannot be acquired due to noise or the like as the indefinite region. Then, similarly to Step S206 described above, the control unit 500 changes the display position or the display form of the virtual object 600 or the movement amount of the virtual object 600 in the moving image display in the AR device 100 so as to reduce the region where the virtual object 600 and the indefinite region are superimposed (distance dependent control of the indefinite region) (Step S207).

More specifically, in Step S207, similarly to Step S206 described above, in a case where the whole or a part of the virtual object 600 is at a position to be hidden in the indefinite region, control is performed such that the virtual object 600 can be visually recognized or a situation in which the virtual object can be visually recognized immediately comes by increasing the movement amount in the parallel direction (increasing the movement speed or warping). Furthermore, in a similar case, in Step S207, as in Step S206 described above, the virtual object 600 may be controlled to jump high so that the virtual object 600 can be visually recognized. Furthermore, in the present embodiment, the movable direction of the virtual object 600 may be limited so that the virtual object 600 can be visually recognized.

Furthermore, in Step S207, as illustrated in FIG. 11, the AR device 100 may display another virtual object (another virtual object) 610 so as to correspond to the indefinite region.

Since Steps S208 and S209 are similar to Steps S104 and S105 of the first embodiment illustrated in FIG. 3, the description thereof is omitted here.

Also in the present embodiment, as in the first embodiment, the information processing method illustrated in FIG. 9 may be repeatedly executed using a change in the virtual position of the virtual object 600 in the real space or a change in the position or posture of the user 900 as a trigger. In this way, the virtual object 600 displayed in the AR by the AR device 100 can be perceived by the user 900 as the real object existing in the real space.

As described above, according to the present embodiment, even in a case where the shielding object 802 that blocks the view of the user 900 exists between the user 900 and the virtual object 600 in the real space, the user 900 can easily view the virtual object 600 using the display unit 102 of the AR device 100. As a result, according to the present embodiment, it is easy for the user 900 to operate the virtual object 600.

### 4. Third Embodiment

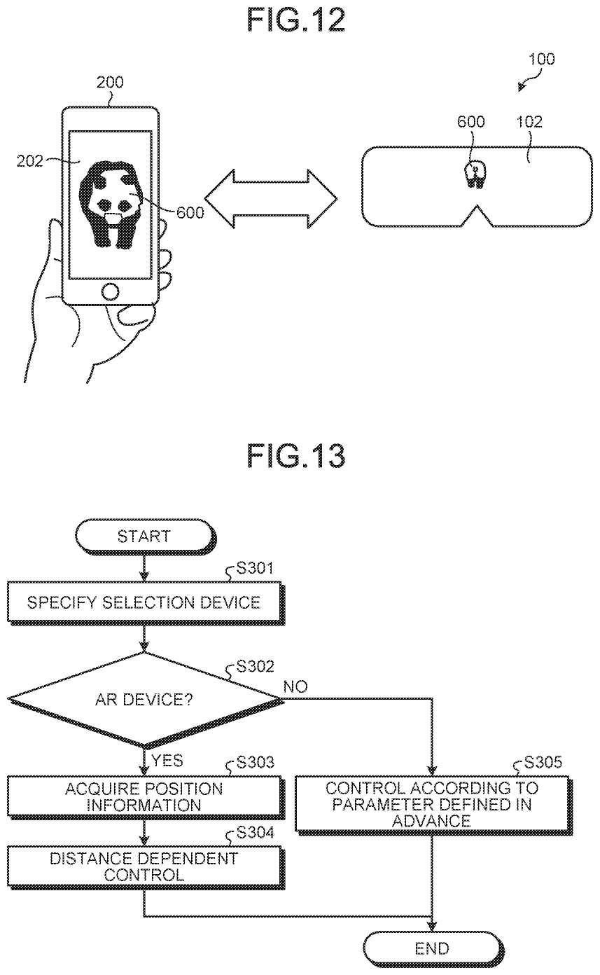

First, a situation assumed in a third embodiment of the present disclosure will be described with reference to FIG. 12. FIG. 13 is an explanatory diagram for describing an outline of the present embodiment. For example, when a user 900 plays a game using an information processing system 10 according to the present embodiment, as illustrated in FIG. 12, it is assumed that the user 900 visually recognizes the same virtual object 600 and can operate a virtual object using both an AR device 100 and a non-AR device 200. That is, the operation on the virtual object 600 using the AR device 100 and the non-AR device 200 is not exclusive.

In such a situation, the user 900 is required to control the display of the virtual object 600 according to a device selected as a controller (operation device) from the AR device 100 and the non-AR device 200. In other words, in such a situation, even when the operation on the virtual object 600 is the same for the user 900, it is required to further improve a user experience and operability by changing the form (for example, a change amount or the like) of the virtual object 600 displayed in each case according to the device selected as the controller.

Therefore, in the present embodiment, the device selected as the controller by the user 900 is specified on the basis of the line-of-sight of the user 900, and the display of the virtual object 600 is dynamically changed on the basis of the specified result. In the present embodiment, for example, in a case where the user 900 selects the AR device 100, the distance-dependent control as described above is performed in the display of the virtual object 600, and in a case where the user 900 selects the non-AR device 200, the control is performed with a parameter defined in advance in the display of the virtual object 600. According to the present embodiment, by performing control in this manner, the form of the virtual object 600 to be displayed changes according to the device selected as the controller even when the operation on the virtual object 600 is the same for the user 900, and thus, it is possible to further improve user experience and operability.

Furthermore, in the present embodiment, the device selected as the controller by the user 900 is specified on the basis of the direction of the line-of-sight of the user 900. However, in the situation described above, since the user 900 can use both the AR device 100 and the non-AR device 200, the destination of the line-of-sight is not determined to be one, and it is assumed that the user is constantly moving. Therefore, in a case where the destination of the line-of-sight is not constantly fixed, it is difficult to specify the device on the basis of the direction of the line-of-sight of the user 900, and further, it is difficult to specify the device with high accuracy. Furthermore, in a case where the selection device is simply specified on the basis of the direction of the user's line-of-sight, and the display of the virtual object 600 is dynamically changed on the basis of the specified result, it is conceivable that the movement of the virtual object 600 becomes discontinuous every time the specified device changes, and the operability is rather deteriorated.

Therefore, in the present embodiment, the probability that the user 900 selects each device as the controller is calculated, the device selected as the controller by the user 900 is specified on the basis of the calculated probability, and the display of the virtual object 600 is dynamically changed on the basis of the specified result. According to the present embodiment, by doing so, even in a case where the destination of the line-of-sight of the user 900 is not constantly fixed, the device selected as the controller can be accurately specified on the basis of the direction of the line-of-sight of the user 900. Furthermore, according to the present embodiment, by doing so, the movement of the virtual object 600 can be suppressed from becoming discontinuous, and a decrease in operability can be avoided.

<4.1 Detailed Configuration of Control Unit 500>

Configuration examples of the information processing system 10 and a control unit 500 according to the present embodiment are similar to those of the first embodiment, and thus, description thereof is omitted here. However, in the present embodiment, the control unit 500 also has the following functions.

Specifically, in the present embodiment, an object control section 504 can dynamically change the parameter related to the display of the virtual object 600 such that, for example, the display change amount changed by the input operation of the user 900 changes according to the device selected by the user 900 as the controller.

<4.2 Information Processing Method>

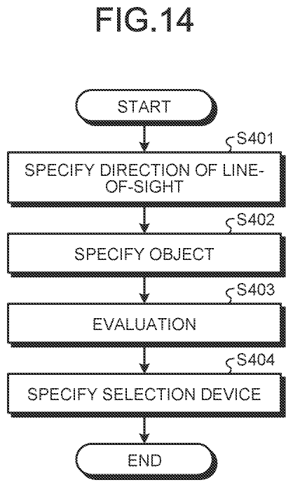

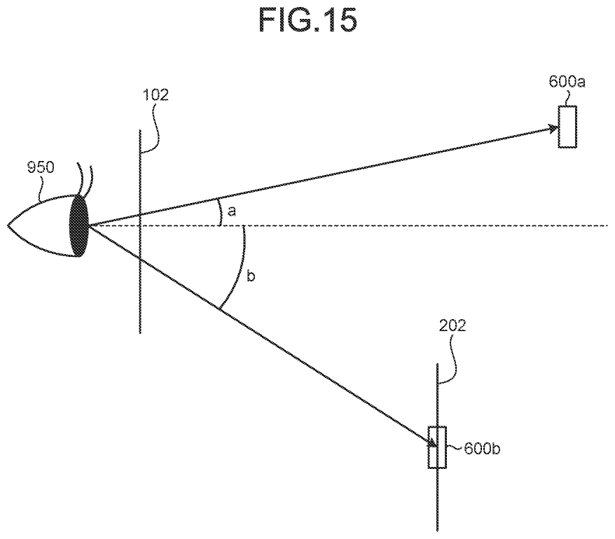

Next, an information processing method according to a third embodiment of the present disclosure will be described with reference to FIGS. 13 to 15. FIGS. 13 and 14 are flowcharts illustrating an example of the information processing method according to the present embodiment, and specifically, FIG. 14 is a sub-flowchart of Step S301 illustrated in FIG. 13. Furthermore, FIG. 15 is an explanatory diagram for describing an example of a method of specifying a selection device according to the present embodiment.

Specifically, as illustrated in FIG. 13, the information processing method according to the present embodiment can include Steps from Step S301 to Step S305. Details of these Steps according to the present embodiment will be described below. Note that, in the following description, only points different from the above-described first embodiment will be described, and description of points common to the first embodiment will be omitted.

First, the control unit 500 specifies a device selected as a controller by the user 900 on the basis of the line-of-sight of the user 900 (Step S301). Note that the detailed processing in Step S301 will be described later with reference to FIG. 14.

Next, the control unit 500 determines whether or not the device specified in Step S301 described above is the AR device 100 (Step S302). When the specified device is the AR device 100 (Step S302: Yes), the processing proceeds to Step S303, and when the specified device is the non-AR device 200 (Step S302: No), the processing proceeds to Step S305.

Since Steps S303 to S305 are similar to Steps S102, S103, and S105 of the first embodiment illustrated in FIG. 3, the description thereof will be omitted here.

Note that, in the present embodiment as well, as in the first embodiment, the information processing method illustrated in FIG. 13 may be repeatedly executed using a change in the virtual position of the virtual object 600 in the real space or a change in the position or posture of the user 900 as a trigger. In this way, the virtual object 600 displayed in the AR by the AR device 100 can be perceived by the user 900 as the real object existing in the real space. Furthermore, in the present embodiment, a change in the device selected as the controller by the user 900 on the basis of the line-of-sight of the user 900 may be used as a trigger, and the change may be repeatedly executed.

Next, detailed processing of Step S301 in FIG. 13 will be described with reference to FIG. 14. Specifically, as illustrated in FIG. 14, Step S301 according to the present embodiment may include sub-steps from Step S401 to Step S404. Details of these Steps according to the present embodiment will be described below.

First, the control unit 500 specifies the direction of the line-of-sight of the user 900 on the basis of the sensing data from the line-of-sight sensor unit 400 that detects the movement of the eyeball of the user 900 (Step S401). Specifically, for example, the control unit 500 can specify the line-of-sight direction of the user 900 on the basis of the positional relationship between the inner corner of the eye and the iris by using the captured image of the eyeball of the user 900 obtained by the line-of-sight sensor unit 400. Note that, in the present embodiment, since the movement of the eyeball of the user is always occurring in the line-of-sight direction of the user 900 specified within the predetermined time, a plurality of results may be obtained. Furthermore, in Step S401, the line-of-sight direction of the user 900 may be specified using a model obtained by machine learning.

Next, the control unit 500 specifies the virtual object 600 to which the user 900 pays attention on the basis of the line-of-sight direction specified in Step S401 described above (Step S402). For example, as illustrated in FIG. 15, by an angle a and an angle b in the line-of-sight direction with respect to a horizontal line extending from the eyes 950 of the user 900, it is possible to specify whether the virtual object 600 of interest of the user 900 is the virtual object 600a displayed on the AR device 100 illustrated on the upper side in FIG. 15 or the virtual object 600b displayed on the non-AR device 200 illustrated on the lower side in FIG. 15. Note that, in the present embodiment, in a case where results of a plurality of line-of-sight directions are obtained, the virtual object 600 that corresponds to each line-of-sight direction and that the user 900 pays attention to is specified. Furthermore, in Step S402, the virtual object 600 of interest of the user 900 may be specified using the model obtained by the machine learning.

Next, the control unit 500 calculates a probability that the user 900 pays attention to the virtual object 600 specified in Step S402 described above, calculates a probability that the user 900 selects a device for displaying each virtual object 600 as a controller, and evaluates the specified result (Step S403).

Specifically, for example, in the case of the moving virtual object 600, the probability of being paid attention to by the user 900 is high, and in the case of the virtual object 600 having a vivid color, for example, the probability of being paid attention to by the user 900 is high. Furthermore, for example, the virtual object 600 displayed with a voice output (effect) as if being uttered is also highly likely to receive attention from the user 900. Furthermore, in a case where the virtual object 600 is a character of a game, the probability of being noticed by the user 900 differs depending on the profile (role (protagonist, colleague, enemy), or the like) assigned to the character. Therefore, the probability that each virtual object 600 is noticed by the user 900 is calculated on the basis of such information (operation, size, shape, color, profile) regarding the specified virtual object 600. Note that, at this time, the control unit 500 may calculate the probability using a model or the like obtained by machine learning, and in addition, may calculate the probability using the motion or the like of the user 900 detected by a motion sensor (not illustrated) provided in the AR device 100, or the position, posture, or the like of the non-AR device 200 detected by a motion sensor (not illustrated) provided in the non-AR device 200. Furthermore, in a case where the user 900 is playing a game using the information processing system 10 according to the present embodiment, the control unit 500 may calculate the probability using a situation on the game. Note that, in the present embodiment, the calculated probability may be used when a parameter related to display of the virtual object 600 is changed.

Then, the control unit 500 specifies the selection device on the basis of the calculated probability (Step S404). In the present embodiment, for example, when the calculated probability is a predetermined value or more, the device displaying the virtual object 600 corresponding to the probability is specified as the selection device selected as the controller from the user 900. Furthermore, in the present embodiment, for example, a device that displays the virtual object 600 corresponding to the highest probability is specified as the selection device. Furthermore, in the present embodiment, the selection device may be specified by performing statistical processing such as extrapolation using the calculated probability. According to the present embodiment, by doing so, even in a case where the destination of the line-of-sight of the user 900 is not constantly fixed, the device selected as the controller can be accurately specified on the basis of the direction of the line-of-sight of the user 900.

As described above, in the present embodiment, the device selected as the controller by the user 900 is specified on the basis of the line-of-sight of the user 900, and the display of the virtual object 600 can be dynamically changed on the basis of the specified result. According to the present embodiment, by performing control in this manner, the form of the virtual object 600 to be displayed changes according to the device selected as the controller even when the operation on the virtual object 600 is the same for the user 900, and thus, it is possible to further improve user experience and operability.

Furthermore, in the present embodiment, the probability (specifically, the probability that the user 900 pays attention to the virtual object 600.) that the user 900 selects each device as a controller is calculated, the device selected as a controller by the user 900 is specified on the basis of the calculated probability, and the display of the virtual object 600 is dynamically changed on the basis of the specified result. According to the present embodiment, by doing so, even in a case where the destination of the line-of-sight of the user 900 is not constantly fixed, the device selected as the controller can be accurately specified on the basis of the direction of the line-of-sight of the user 900. Furthermore, according to the present embodiment, by doing so, the movement of the virtual object 600 can be suppressed from becoming discontinuous, and a decrease in operability can be avoided.

Furthermore, in the present embodiment, in order to prevent the movement of the virtual object 600 from becoming discontinuous due to frequent changes in the parameters (control parameters) related to the display of the virtual object 600 due to the movement of the line-of-sight of the user 900, the parameters related to the display of the virtual object 600 may be adjusted (interpolated) using the probability of selecting each device instead of directly selecting the parameters related to the display of the virtual object 600 using the probability of selecting each device. For example, it is assumed that the probability that the device has been selected as the controller obtained on the basis of the direction of the line-of-sight of the user 900 is 0.3 in a device a and 0.7 in a device b. Then, it is assumed that a control parameter when the device a is selected as the controller is Ca, and a control parameter when the device b is selected is Cb. In such a case, instead of setting the final control parameter C to Cb on the basis of the device b having a high probability of selecting the device as the controller, the final control parameter C may be obtained by interpolating the final control parameter C in a form of, for example, C=0.3×Ca+0.7×Cb using the probability of selecting each device. In this way, the movement of the virtual object 600 can be suppressed from being discontinuous.

Note that, in the present embodiment, in order to prevent the movement of the virtual object 600 from becoming discontinuous due to frequent changes in the parameters related to the display of the virtual object 600 due to the movement of the line-of-sight of the user 900, the frequency or the amount of change in the parameters may be limited by being set in advance by the user 900. Furthermore, in the present embodiment, for example, the parameter related to the display of the virtual object 600 may be limited not to be changed while the operation of the user 900 is continuously performed. Furthermore, in the present embodiment, the detection that the user 900 gazes at the specific virtual object 600 for a predetermined time or more may be used as a trigger to change the parameter related to the display of the virtual object 600. Furthermore, in the present embodiment, the parameter related to the display of the virtual object 600 may be changed by using, as a trigger, not only the identification of the selection device according to the direction of the line-of-sight of the user 900, but also the detection that the user 900 has performed a predetermined operation.

Furthermore, in the present embodiment, in order to cause the user 900 to recognize which device is specified as the controller, for example, when the AR device 100 is specified as the controller, the image from the viewpoint 702 provided on the virtual object 600 may not be displayed in the non-AR device 200. Furthermore, similarly, for example, when the non-AR device 200 is specified as the controller, the same image as the image displayed by the non-AR device 200 may be displayed on the AR device 100.

<4.3. Modification Example>

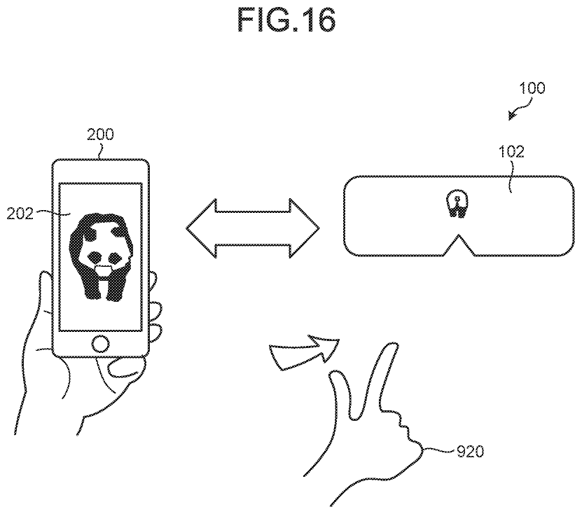

Furthermore, in the present embodiment, not only the direction of the line-of-sight of the user 900 may be detected, but also a gesture of the user 900 may be detected, so that the selection device selected by the user 900 as the controller is specified. Hereinafter, a modification example of the present embodiment will be described with reference to FIG. 16. FIG. 16 is an explanatory diagram for describing an outline of a modification example of the third embodiment of the present disclosure.

Specifically, in the present modification example, in a case where a predetermined gesture as illustrated in FIG. 16 is detected from an image of an imaging device (gesture detection device) (not illustrated) that images a motion of a hand 920 of the user 900, the control unit 500 specifies the selection device selected by the user 900 as the controller on the basis of the detected gesture.

Furthermore, in the present modification example, in a case where the AR device 100 is an HMD, a motion sensor (not illustrated) provided in the HMD may detect the movement of the head of the user 900 wearing the HMD, and the selection device selected by the user 900 as the controller may be specified on the basis of the detected movement of the head. Furthermore, in the present modification example, in a case where a sound sensor (not illustrated) is provided in the AR device 100, the non-AR device 200, or the like, the selection device selected by the user 900 as the controller may be specified on the basis of the voice of the user 900 or a predetermined phrase extracted from the voice.

### 5. Summary

As described above, in each embodiment of the present disclosure, at the time of using a plurality of display devices that simultaneously display the same virtual object 600, in the AR device 100 and the non-AR device having different user's perception manners, the display of the virtual object 600 reacts differently to different forms, different changes, or operations from the user 900, and thus, it is possible to further improve user experience and operability.

Note that, in each embodiment of the present disclosure, as described above, the virtual object 600 is not limited to a character, an item, or the like of a game, and may be, for example, an icon, a text (a button or the like), a three-dimensional image, or the like as a user interface in another application (business tool), and is not particularly limited.

### 6. Hardware Configuration

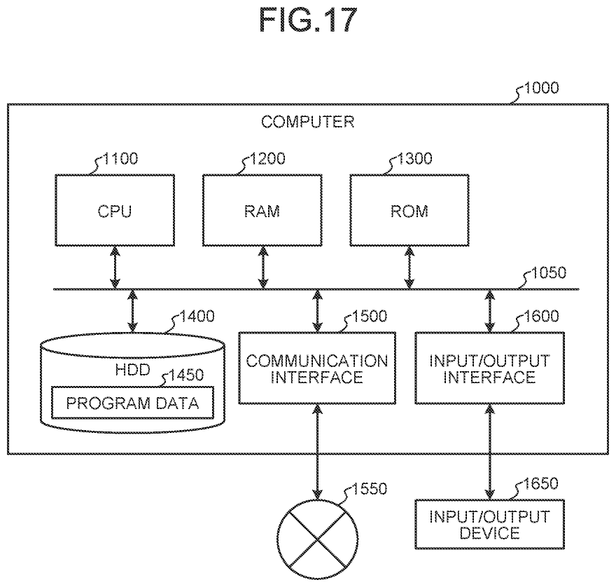

The information processing apparatus such as the control unit 500 according to each embodiment described above is realized by the computer 1000 having a configuration as illustrated in FIG. 17, for example. Hereinafter, the control unit 500 according to the embodiment of the present disclosure will be described as an example. FIG. 17 is a hardware configuration diagram illustrating an example of a computer 1000 that implements the functions of the control unit 500. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting the input/output device 1650 and the computer 1000. For example, the CPU 1100 receives data from the input/output device 1650 such as a keyboard, a mouse, and a microphone (microphone) via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the control unit 500 according to the embodiment of the present disclosure, the CPU 1100 of the computer 1000 realizes the functions of the control section 200 and the like by executing a program stored in the RAM 1200. In addition, the HDD 1400 stores an information processing program and the like according to the present disclosure. Note that the CPU 1100 reads the program data 1450 from the HDD 1400 and executes the program data, but as another example, these programs may be acquired from another device via the external network 1550.

Furthermore, the information processing apparatus according to the present embodiment may be applied to a system including a plurality of devices on the premise of connection to a network (or communication between devices), such as cloud computing. That is, the information processing apparatus according to the present embodiment described above can be implemented as the information processing system according to the present embodiment by a plurality of devices, for example.

An example of the hardware configuration of the control unit 500 has been described above. Each of the above-described components may be configured using a general-purpose member, or may be configured by hardware specialized for the function of each component. Such a configuration can be appropriately changed according to the technical level at the time of implementation.

### 7. Supplement

Note that the embodiment of the present disclosure described above can include, for example, an information processing method executed by the information processing apparatus or the information processing system as described above, a program for causing the information processing apparatus to function, and a non-transitory tangible medium in which the program is recorded. Further, the program may be distributed via a communication line (including wireless communication) such as the Internet.

Furthermore, each step in the information processing method according to the embodiment of the present disclosure described above may not necessarily be processed in the described order. For example, each step may be processed in an appropriately changed order. In addition, each step may be partially processed in parallel or individually instead of being processed in time series. Furthermore, the processing of each step does not necessarily have to be performed according to the described method, and may be performed by another method by another functional unit, for example.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

Note that the present technology can also have the following configurations.
(1) An information processing apparatus comprising:

a control section configured to dynamically change each parameter related to display of a virtual object, the parameter controlling display of the virtual object on each display device according to a method of expressing an image, the method being assigned for display of the image to each of a plurality of display devices that display an image related to a same virtual object.
(2) The information processing apparatus according to (1),

wherein the plurality of display devices include

a first display device that is controlled to display scenery of a real space in which the virtual object is virtually arranged, the scenery being viewed from a first viewpoint defined as a viewpoint of a user in the real space, and

a second display device that is controlled to display an image of the virtual object.
(3) The information processing apparatus according to (2),

wherein the control section dynamically changes the parameter for controlling the first display device according to three-dimensional information of the real space around the user from a real space information acquisition device.
(4) The information processing apparatus according to (3),

wherein the real space information acquisition device is an imaging device that images the real space around the user or a distance measuring device that acquires depth information of the real space around the user.
(5) The information processing apparatus according to (3) or (4),

wherein when a region in which a shielding object located between the virtual object and the user is present in the real space or a region in which the three-dimensional information cannot be acquired is detected on the basis of the three-dimensional information,

the control section sets the region as an occlusion region, and changes a display position or a display form of the virtual object or a movement amount of the virtual object in moving image display on the first display device so as to reduce a region in which the virtual object and the occlusion region are superimposed.
(6) The information processing apparatus according to (5),

wherein the control section controls the first display device so as to display another virtual object in an indefinite region where the three-dimensional information cannot be acquired.
(7) The information processing apparatus according to any one of (2) to (6), further comprising a position information acquisition unit that acquires position information including distance information and positional relationship information between the virtual object and the user in the real space,

wherein the control section dynamically changes the parameter for controlling the first display device according to the position information.
(8) The information processing apparatus according to (7),

wherein the control section performs control such that a display area of the virtual object to be displayed on the first display device increases as a distance between the virtual object and the user increases.
(9) The information processing apparatus according to (7),

wherein the control section performs control such that a display change amount in moving image display of the virtual object to be displayed on the first display device increases as a distance between the virtual object and the user increases.
(10) The information processing apparatus according to (7),

wherein the control section performs control to further smooth a trajectory in moving image display of the virtual object to be displayed on the first display device as a distance between the virtual object and the user increases.
(11) The information processing apparatus according to (7),

the control section dynamically changes a display change amount of the virtual object to be displayed on the first display device, the display change amount being changed by an input operation of the user, according to the position information.
(12) The information processing apparatus according to any one of (2) to (11),

the control section controls the second display device so as to display an image of the virtual object visually recognized from a second viewpoint different from the first viewpoint in the real space.
(13) The information processing apparatus according to (12),

wherein the second viewpoint is virtually arranged on the virtual object.
(14) The information processing apparatus according to (2),

wherein the control section changes a display change amount of the virtual object to be displayed on each of the first and second display devices in moving image display according to the method of expressing the image assigned to each of the first and second display devices for displaying the image.
(15) The information processing apparatus according to (2), further comprising a selection result acquisition unit that acquires a selection result indicating whether the user has selected one of the first display device and the second display device as an input device,

wherein the control section dynamically changes a display change amount of the virtual object changed by an input operation of the user according to the selection result.
(16) The information processing apparatus according to (15),

wherein the selection result acquisition unit acquires the selection result on a basis of a detection result of a line-of-sight of the user from a line-of-sight detection device.
(17) The information processing apparatus according to (15),

wherein the selection result acquisition unit acquires the selection result on a basis of a detection result of a gesture of the user from a gesture detection device.
(18) The information processing apparatus according to any one of (2) to (17),

wherein the first display device superimposes and displays an image of the virtual object on an image of the real space,

projects and displays the image of the virtual object in the real space, or

projects and displays the image of the virtual object on a retina of the user.
(19) An information processing method comprising:

dynamically changing, by an information processing apparatus, each parameter related to display of a virtual object, the parameter controlling display of the virtual object on each display device according to a method of expressing an image, the method being assigned for display of the image to each of a plurality of display devices that display an image related to a same virtual object.
(20) A program causing a computer to function as a control section that dynamically changes each parameter related to display of a virtual object, the parameter controlling display of the virtual object on each display device according to a method of expressing an image, the method being assigned for display of the image to each of a plurality of display devices that display an image related to a same virtual object.

### REFERENCE SIGNS LIST

10 INFORMATION PROCESSING SYSTEM

100 AR DEVICE

102, 202 DISPLAY UNIT

104, 204 CONTROL SECTION

200 NON-AR DEVICE

300 DEPTH MEASUREMENT UNIT

302 DEPTH SENSOR UNIT

304 STORAGE UNIT

400 LINE-OF-SIGHT SENSOR UNIT

500 CONTROL UNIT

502 THREE-DIMENSIONAL INFORMATION ACQUISITION UNIT

504 OBJECT CONTROL SECTION

506 AR DEVICE RENDERING UNIT

508 NON-AR DEVICE RENDERING UNIT

510 DETECTION UNIT

512 LINE-OF-SIGHT DETECTION UNIT

514 LINE-OF-SIGHT ANALYSIS UNIT

520 LINE-OF-SIGHT EVALUATION UNIT

600, 600a, 600b, 602, 610 VIRTUAL OBJECT

650 AVATAR

700, 702 VIEWPOINT

800 REAL OBJECT

802 SHIELDING OBJECT

900 USER

920 HAND

950 EYE

a, b ANGLE

1. An information processing apparatus comprising:
a control section configured to dynamically change each parameter related to display of a virtual object, the parameter controlling display of the virtual object on each display device according to a method of expressing an image, the method being assigned for display of the image to each of a plurality of display devices that display an image related to a same virtual object.

2. The information processing apparatus according to claim 1,
wherein the plurality of display devices include
a first display device that is controlled to display scenery of a real space in which the virtual object is virtually arranged, the scenery being viewed from a first viewpoint defined as a viewpoint of a user in the real space, and
a second display device that is controlled to display an image of the virtual object.

3. The information processing apparatus according to claim 2,
wherein the control section dynamically changes the parameter for controlling the first display device according to three-dimensional information of the real space around the user from a real space information acquisition device.

4. The information processing apparatus according to claim 3,
wherein the real space information acquisition device is an imaging device that images the real space around the user or a distance measuring device that acquires depth information of the real space around the user.

5. The information processing apparatus according to claim 3,
wherein when a region in which a shielding object located between the virtual object and the user is present in the real space or a region in which the three-dimensional information cannot be acquired is detected on the basis of the three-dimensional information,
the control section sets the region as an occlusion region, and changes a display position or a display form of the virtual object or a movement amount of the virtual object in moving image display on the first display device so as to reduce a region in which the virtual object and the occlusion region are superimposed.

6. The information processing apparatus according to claim 5,
wherein the control section controls the first display device so as to display another virtual object in an indefinite region where the three-dimensional information cannot be acquired.

7. The information processing apparatus according to claim 2, further comprising a position information acquisition unit that acquires position information including distance information and positional relationship information between the virtual object and the user in the real space,
wherein the control section dynamically changes the parameter for controlling the first display device according to the position information.

8. The information processing apparatus according to claim 7,
wherein the control section performs control such that a display area of the virtual object to be displayed on the first display device increases as a distance between the virtual object and the user increases.

9. The information processing apparatus according to claim 7,
wherein the control section performs control such that a display change amount in moving image display of the virtual object to be displayed on the first display device increases as a distance between the virtual object and the user increases.

10. The information processing apparatus according to claim 7,
wherein the control section performs control to further smooth a trajectory in moving image display of the virtual object to be displayed on the first display device as a distance between the virtual object and the user increases.

11. The information processing apparatus according to claim 7,
the control section dynamically changes a display change amount of the virtual object to be displayed on the first display device, the display change amount being changed by an input operation of the user, according to the position information.

12. The information processing apparatus according to claim 2,
the control section controls the second display device so as to display an image of the virtual object visually recognized from a second viewpoint different from the first viewpoint in the real space.

13. The information processing apparatus according to claim 12,
wherein the second viewpoint is virtually arranged on the virtual object.

14. The information processing apparatus according to claim 2,
wherein the control section changes a display change amount of the virtual object to be displayed on each of the first and second display devices in moving image display according to the method of expressing the image assigned to each of the first and second display devices for displaying the image.

15. The information processing apparatus according to claim 2, further comprising a selection result acquisition unit that acquires a selection result indicating whether the user has selected one of the first display device and the second display device as an input device,
wherein the control section dynamically changes a display change amount of the virtual object changed by an input operation of the user according to the selection result.

16. The information processing apparatus according to claim 15,
wherein the selection result acquisition unit acquires the selection result on a basis of a detection result of a line-of-sight of the user from a line-of-sight detection device.

17. The information processing apparatus according to claim 15,
wherein the selection result acquisition unit acquires the selection result on a basis of a detection result of a gesture of the user from a gesture detection device.

18. The information processing apparatus according to claim 2,
wherein the first display device superimposes and displays an image of the virtual object on an image of the real space,
projects and displays the image of the virtual object in the real space, or
projects and displays the image of the virtual object on a retina of the user.

19. An information processing method comprising:
dynamically changing, by an information processing apparatus, each parameter related to display of a virtual object, the parameter controlling display of the virtual object on each display device according to a method of expressing an image, the method being assigned for display of the image to each of a plurality of display devices that display an image related to a same virtual object.

20. A program causing a computer to function as a control section that dynamically changes each parameter related to display of a virtual object, the parameter controlling display of the virtual object on each display device according to a method of expressing an image, the method being assigned for display of the image to each of a plurality of display devices that display an image related to a same virtual object.
